(19) United States
(12) Patent Application Publication
(10) Pub. No.: US 2019/0300153 A1
(43) Pub. Date: Oct. 3, 2019

(54) PROPELLER CYCLIC CONTROL FOR FLYING WING LIFT AUGMENTATION

(71) Applicant: Northrop Grumman Systems Corporation, Falls Church, VA (US)

(72) Inventor: Joel S. Warner, Huntington Beach, CA (US)

(21) Appl. No.: 15/942,696

(22) Filed: Apr. 2, 2018

(51) Int. Cl. B64C 11/40; B64C 29/00; B64C 27/28

(52) U.S. Cl. CPC B64C 11/40; B64C 27/28; B64C 29/0033

(57) ABSTRACT

A method of controlling a VTOL unmanned flying wing aircraft using improved proprotor cyclic controls during wing-borne flight is disclosed and claimed. Cyclic control of the proprotor during wing-borne flight allows the aerodynamic, or trailing-edge, controls to be deflected trailing-edge-down in trimmed flight, thus augmenting lift, reducing power-on stall speed, improving loiter endurance and propulsive range, and facilitating transition maneuvers between rotor-borne and wing-borne flight phases. Additionally, cyclic control of the proprotor during wing-borne flight may be used to implement a speed-brake type of functionality in the aircraft, for example.

### GOVERNMENT CONTRACT

The Government of the United States of America has rights in this invention pursuant to Government Contract No. HR0011-13-C-0096.

### TECHNICAL FIELD

The invention relates generally to flying wing aircraft and more particularly to vertical takeoff or landing (VTOL) unmanned flying wing aircraft.

### BACKGROUND

Helicopters are rotor based aircraft that manipulate rotor blade pitch for flight control, which enables them to take off and land vertically, to hover, and to fly forward, backward, and laterally. Two types of blade control are used; a collective control changes the pitch of all blades equally to modulate thrust, and a cyclic control continually changes the pitch of each blade as it revolves in order to tilt the thrust.

On the other hand, propeller-driven fixed-wing aircraft require a runway for takeoff and landing, and are unable to hover in flight. Fixed-wing aircraft generally have a collective-type propeller control but do not have cyclic control capability. A particular type of fixed-wing aircraft is a flying wing aircraft which is defined as one that lacks physically offset pitch axis aerodynamic controls. Flying wing aircraft typically have no tail or well defined fuselage.

### SUMMARY

Example embodiments encompass a method of controlling a VTOL unmanned flying wing aircraft using improved proprotor cyclic controls during wing-borne flight. Cyclic control of the proprotor during wing-borne flight allows the aerodynamic, or trailing-edge, controls to be deflected trailing-edge-down in trimmed flight, thus augmenting lift, reducing power-on stall speed, improving loiter endurance and propulsive range, and facilitating transition maneuvers between rotor-borne and wing-borne flight phases. Additionally, cyclic control of the proprotor during wing-borne flight is used to implement, for example, a speed-brake type of functionality in the aircraft.

A representative embodiment encompasses a method of controlling a VTOL flying wing aircraft having a proprotor, including steps of establishing wing-borne flight; applying a cyclic deflection to the proprotor; and adjusting one or more trailing-edge controls to establish trim.

In a further embodiment, the cyclic deflection is applied in in a lower quadrant of the proprotor. Further, the cyclic deflection of a continuous range of values up to the aerodynamic stall limit of the proprotor blades is applied resulting in a reduced angle of attack and a trailing-edge control deflection of the aircraft for a given load factor.

In an alternative embodiment, the cyclic deflection of a continuous range of values up to the aerodynamic stall limit of the proprotor blades is applied resulting in an increased angle of attack and a trailing-edge control deflection of the aircraft for a given load factor.

In a further embodiment, the proprotor comprises coaxial tandem proprotors.

In yet another embodiment, the proprotor comprises multiple distributed proprotors.

### DESCRIPTION OF THE DRAWINGS

Features of example implementations of the invention will become apparent from the description, the claims, and the accompanying drawings in which:

FIGS. 1A-D depict a prior art flying wing aircraft.

FIGS. 2A-B depict alternate proprotor configurations of the flying wing aircraft of FIGS. 1A-D.

FIG. 3 depicts a flying wing aircraft during transition to wing-borne flight.

FIG. 4 depicts a flying wing aircraft with improved lift augmentation.

FIG. 5 depicts a flowchart illustrating a method of using cyclic deflection in a flying wing aircraft.

FIGS. 6A and 6B depict graphs showing the angle of attack and elevator deflection for a range of loads prior to applying the method of FIG. 5.

FIGS. 7A and 7B depict graphs showing the angle of attack and elevator deflection for a range of loads during an increased cyclic deflection according to the method of FIG. 5.

FIGS. 8A and 8B depict graphs showing the angle of attack and elevator deflection for a range of loads during a decreased cyclic deflection according to the method of FIG. 5.

### DETAILED DESCRIPTION

Reference will now be made in detail to one or more embodiments of the invention. While the invention will be described with respect to these embodiments, it should be understood that the invention is not limited to any particular embodiment. On the contrary, the invention includes alternatives, modifications, and equivalents as may come within the spirit and scope of the appended claims. Furthermore, in the following description, numerous specific details are set forth to provide a thorough understanding of the invention. The invention may be practiced without some or all of these specific details. In other instances, well-known structures and principles of operation have not been described in detail to avoid obscuring the invention.

In an embodiment, the invention is encompassed in a vertical takeoff and landing (VTOL) flying wing aircraft. A VTOL flying wing aircraft uses a proprotor in a rotor configuration to take off and land vertically, and the entire aircraft transitions to a use the proprotor as a propeller during horizontal flight.

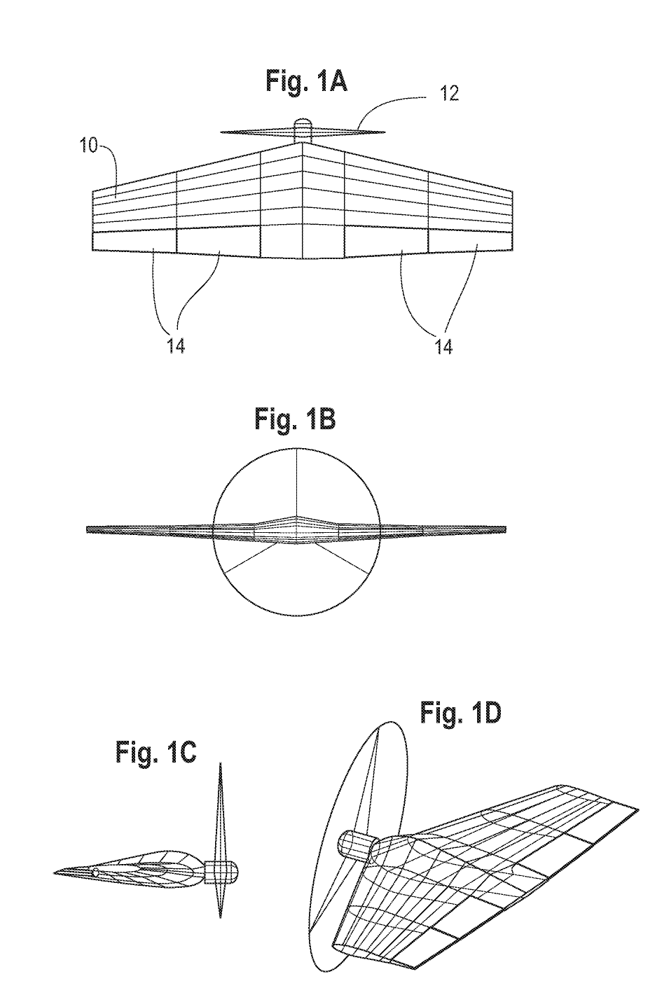

In an embodiment, a VTOL flying wing aircraft is shown in FIGS. 1A-1D. Referring to FIG. 1A, a top view of the aircraft includes a body 10 which forms an aerodynamic shape suitable for wing-borne (non-powered-lift) flight. Proprotor 12 is not articulated relative to the body of the aircraft. Conventional trailing-edge control surfaces 14 provide aerodynamic moments (torques) for flight control. FIG. 1B shows a rear view of the aircraft of FIG. 1A, FIG. 1C shows a side view while FIG. 1D shows a perspective view.

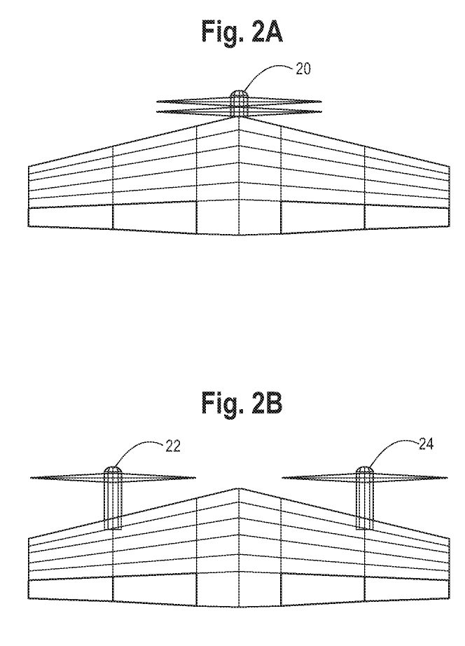

While FIGS. 1A-1D shows a single proprotor at the centerline of body 10. In alternative embodiments, the VTOL flying wing aircraft may be configured with coaxial tandem proprotors 20 as shown in FIG. 2A or multiple distributed proprotors 22 and 24 as shown in FIG. 2B.

During takeoff, proprotor 12 of FIG. 1A uses control movements including cyclic, collective and anti-torque control modes similar to those in helicopters.

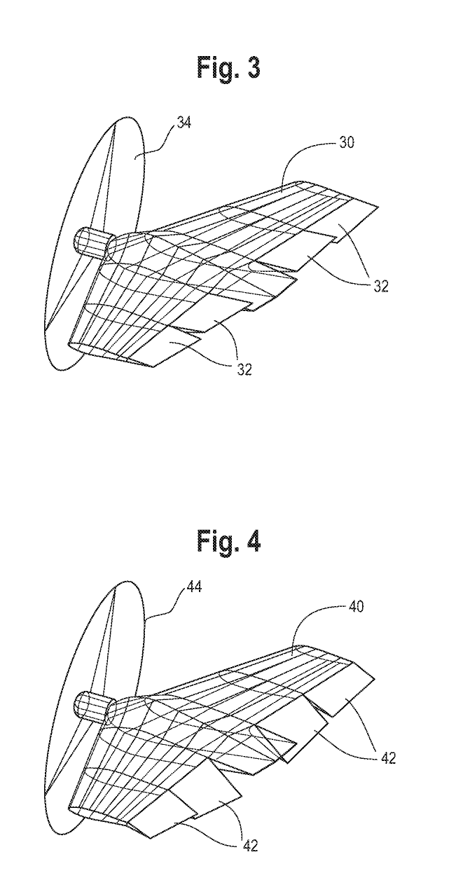

A VTOL flying wing aircraft that has transitioned to wing-borne flight is shown in FIG. 3. Flying wing body 30 includes trailing-edge control surfaces 32 and proprotor 34. Trailing-edge control surfaces 32 are deflected to provide pitch trim, in other words to offset the moments from the aerodynamics of the body/wing shape, the proprotor-induced moments, and any other propulsion-induced moments. Flying wing body 30 includes trailing-edge control surfaces 32 and proprotor 34. In an embodiment, aircraft 40 also includes a vehicle management system (VMS) which provides flight control actuation, stability augmentation, flight management, pilot/crew interface and other functions necessary for aircraft stability, control guidance and navigation. The VMS incorporates at least processing, memory, I/O and communication devices. The VMS may be thought of as an onboard autopilot, however, in an alternative embodiment, the method may be provided in a human-piloted aircraft, as well.

In an embodiment, lift augmentation capability flying wing aircraft 40 is provided as shown in FIG. 4 by using cyclic control in proprotor 44 to generate a pitch moment bias. By using the cyclic control to provide a nose-up bias, trailing-edge aerodynamic control surfaces 42 will achieve trim at a significantly greater trailing-edge-down deflection.

Because the trailing-edge controls 42 are now increasing camber and circulation around the wing, they are increasing the aerodynamic lift at a given airspeed and angle of attack. This provides the benefits normally associated with wing flap systems.

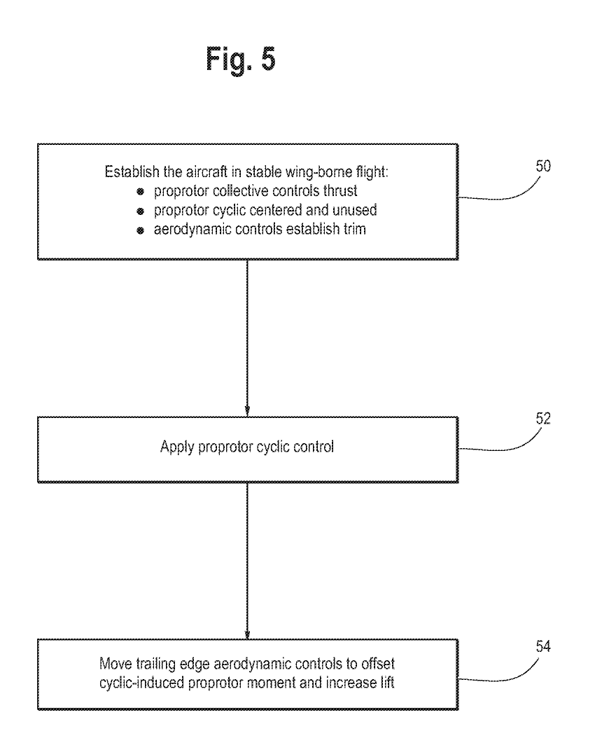

In an embodiment, a method of using cyclic proprotor control during wing-borne flight encompasses the following steps as shown in FIG. 5:

In step 50, the aircraft is established in stable wing-borne flight. This means the proprotor collective control is used to control thrust and therefore airspeed, the proprotor cyclic control is centered and unused, and aerodynamic controls 42 (FIG. 4) are used to establish trim.

A vehicle management system applies a cyclic deflection in step 54 using the proprotor cyclic control to, for example, augment lift the cyclic deflection increases thrust on the lower quadrant of the proprotor disk, creating a nose-up moment.

In step 54, the vehicle management system moves the trailing-edge aerodynamic controls 42 (FIG. 4) to offset the cyclic-induced proprotor moment, which will in this example be deflected trailing-edge down. The aircraft is now in an augmented lift configuration, resembling deployed wing flaps on a conventional airplane.

The increased lift allows the proprotor collective control to be adjusted to that thrust can be reduced to achieve the airspeed or angle of attack flight condition required by the mission phase.

The aircraft may be returned to the initial flight condition by reversing the procedure.

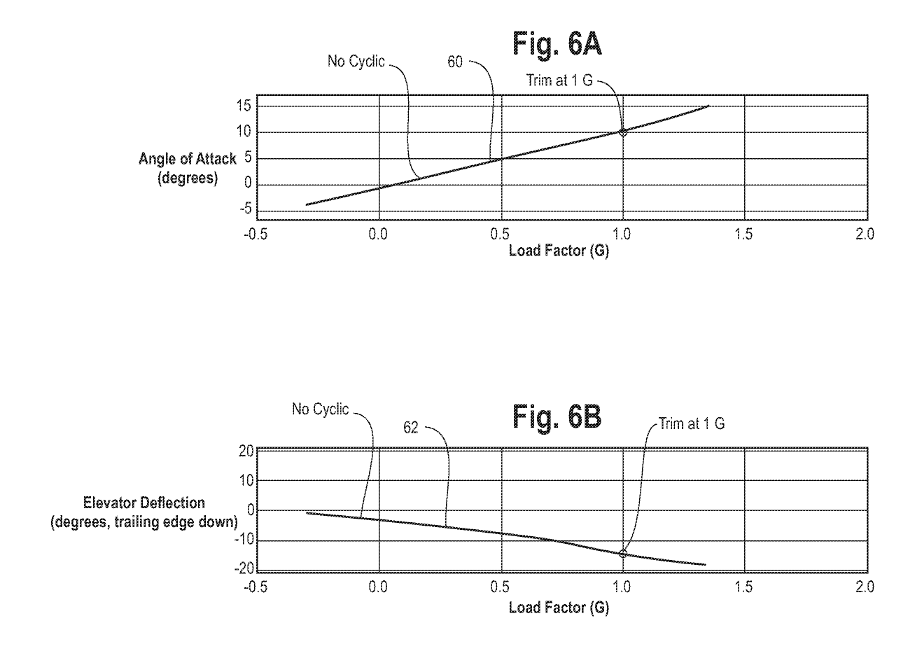

FIGS. 6-8 illustrate the effect of the method of FIG. 5 on a representative flying wing aircraft. FIG. 6A shows angle of attack for a range of loads in an aircraft prior to implementing the method of FIG. 5. The aircraft is trimmed at a particular airspeed and altitude for a range of load factor commands. Line 60 shows angle of attack at trim with no proprotor cyclic; as load factor increases, angle of attack increases proportionally. FIG. 6B shows the corresponding deflection of trailing-edge elevator controls required to trim the aerodynamic and proprotor-induced pitch moment for the same range of load factor commands as line 62.

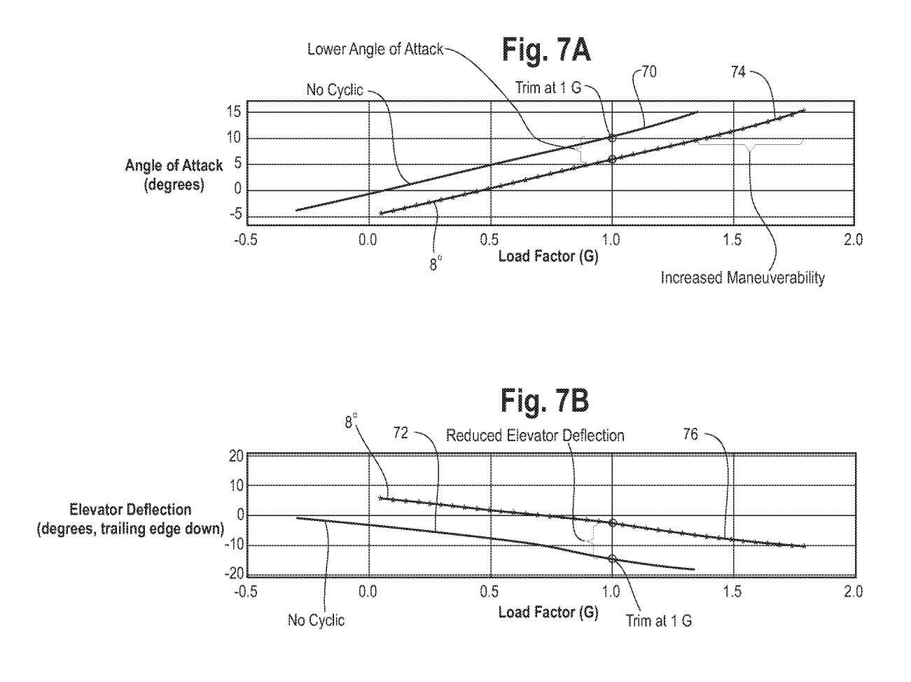

FIGS. 7A and 7B show results for an aircraft that incorporates the method of FIG. 5. Lines 70 and 72 of FIGS. 7A and 7B respectively are the same as lines 60 and 62 in FIGS. 6A and 6B. The aircraft is trimmed for a representative cycle deflection in the proprotor as described above. Although FIGS. 7A and 7B depict 8 degrees of cyclic deflection, a continuous range of cyclic deflections up to the aerodynamic stall limit of the proprotor blades is encompassed by the method. Line 74 of FIG. 7A shows that a given load factor will be achieved at a reduced angle of attack, due to the more trailing-edge-down deflection of the elevator to trim, shown in FIG. 7B as line 76. In an embodiment, the increased cyclic deflection provides increased maneuverability because trim of the aircraft may be achieved at higher loads.

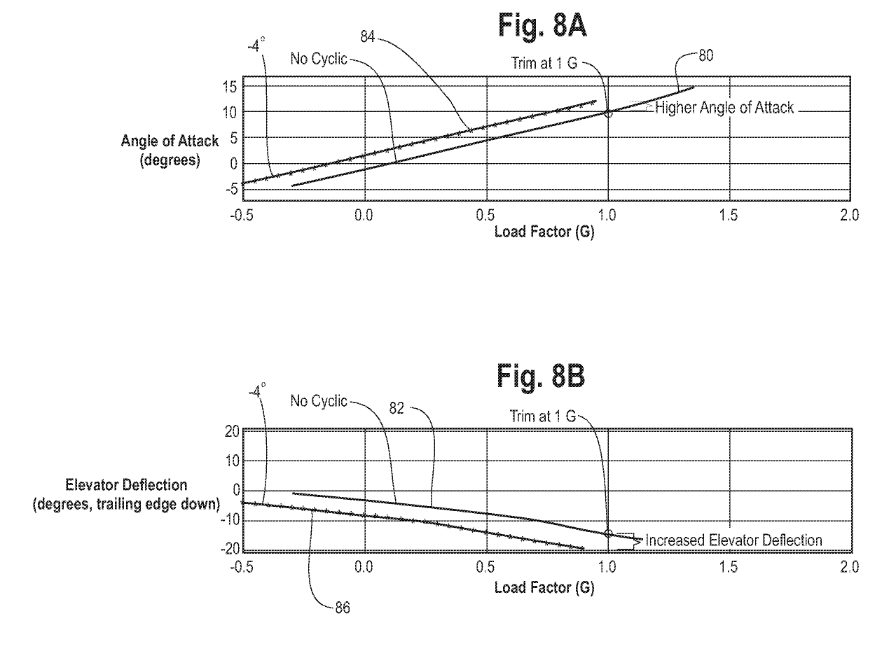

FIGS. 8A and 8B show results for an aircraft that incorporates the method of FIG. 5. Lines 80 and 82 of FIGS. 8A and 8B respectively are the same as lines 60 and 62 in FIGS. 6A and 6B. In FIGS. 8A and 8B, cyclic control is moved in the opposite direction to that shown in FIGS. 7A and 7B, such that lines 84 and 86 show that trailing-edge-up deflection is used to trim the aircraft. Although FIGS. 8A and 8B depict −4 degrees of cyclic deflection, a continuous range of cyclic deflections up to the aerodynamic stall limit of the proprotor blades is encompassed by the method. In an embodiment, the method depicted in FIGS. 8A and 8B may be used to implement a speed-brake type of functionality in the aircraft.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A method of controlling a VTOL flying wing aircraft having a proprotor, the method comprising:
establishing wing-borne flight;
applying a cyclic deflection to the proprotor; and
adjusting one or more trailing-edge controls to establish trim.

2. The method of claim 1, wherein the cyclic deflection is applied in in a lower quadrant of the proprotor.

3. The method of claim 2, wherein the cyclic deflection is a continuous range of values up to the aerodynamic stall limit of the proprotor blades.

4. The method of claim 3, wherein an increased cyclic deflection reduces an angle of attack and a trailing-edge control deflection of the aircraft for a given load factor.

5. The method of claim 2 wherein the cyclic deflection is a continuous range of values up to the aerodynamic stall limit of the proprotor blades.

6. The method of claim 5 wherein a decreased cyclic deflection increases an angle of attack and a trailing-edge control deflection of the aircraft for a given load factor.

7. The method of claim 1 wherein the proprotor comprises coaxial tandem proprotors.

8. The method of claim 1 wherein the proprotor comprises multiple distributed proprotors.
